(19) United States
(12) Patent Application Publication
(10) Pub. No.: US 2004/0083160 A1
(43) Pub. Date: Apr. 29, 2004

(54) Automated agent and method of bidding in electronic auctions

(76) Inventors: Andrew Robert Byde, Bristol (GB); Christopher William Preist, Bristol (GB); Claudio Bartolini, Menlo Park, CA (US)

Correspondence Address: HEWLETT-PACKARD COMPANY, Intellectual Property Administration, P.O. Box 272400, Fort Collins, CO, 80527-2400, US

(21) Appl. No.: 10/462,014

(22) Filed: Jun. 12, 2003

(30) Foreign Application Priority Data
Jun. 13, 2002 (GB) 0213540.8

(51) Int. Cl. G06F 17/60

(52) U.S. Cl. 705/37

(57) ABSTRACT

In many electronic auctions, the auction house will usually set a fixed time for the auction to end and the highest bidder at the termination of the auction is declared the winner. Various bidding strategies are employed by human traders to try to secure goods at artificially low prices, one such strategy being to delay bidding until very close to the deadline for the close of bidding. An automated bidding agent 1 and method of operating the bidding agent 1 are disclosed which have the capacity to evaluate the appropriate last minute bid to place to maximise the chances of securing the goods bid for. The bidding agent 1 comprises a bid model that processes auction data from the e-auction 5 of interest and user preferences input by the user to evaluate the optimal last minute bid to place. The method involves constructing a preference map 8 from the user preferences, and mapping the data held in the preference map 8 using the processed auction data to generate a knowledge base 7 from which the optimal bid to place is evaluated. The bidding agent 1 may typically reside on a user's computer 2.

The present invention relates to a method and apparatus for bidding in electronic auctions on the Internet, and more particularly to an automated agent employing last minute behaviours for bidding in electronic auctions.

The terms ‘auction’ and ‘market’ are used interchangeably in this specification, and refer to an Internet auction or e-marketplace which operates a bidding mechanism.

In a traditional English auction the auctioneer manages the bidding process such that there is no doubt when the auction is about to close. A trader who has not previously bid can make a very late entry but this still allows other traders to respond. In an electronic English auction carried out on a distributed network, the auction house will usually set a fixed time for the auction to end. The highest bidder at the termination of the auction is declared the winner. Human traders often delay bidding until very close to the termination time, and then submit a bid just before auction closure to secure the goods at a cheap price.

The website www.eSnipe.com operates a service whereby users specify a date and time, and a bid value. The website simply automates the placing of the user specified bid at the users specified time. Known autonomous agents such as the eSnipe.com agent, can bid on behalf of a human in an on-line auction, but they do not have the capacity to calculate which bid would stand the best chance of securing the trader's desired goods at the trader's desired price.

According to first aspect of the invention there is provided a method of operating an electronic bidding agent for bidding in an electronic auction, the method comprising the steps of: inputting user preferences; constructing a preference map from the user preferences; monitoring at least one electronic auction; retrieving auction data from at least one electronic auction; processing the auction data; mapping the data from the preference map using the processed auction data to generate a knowledge base for the or each auction; evaluating from the knowledge base an optimal bid or bids to submit to the auction or auctions to outbid the current bid or bids and to maximise the probability of winning at least one auction; and submitting the optimal bid or bids to the auction or auctions, wherein the optimal bid has a value and time of submission close to a deadline for the close of bidding and it determined from interrogating the knowledge base.

According to second aspect of the invention there is provided an electronic bidding agent employing last minute behaviours comprising: a user interface for enabling user preferences to be input and for communicating with the user; monitoring means for monitoring auction data received from at least one electronic auction; and a bid model for processing the auction data and the user preferences to evaluate an optimal bid for the or each electronic auction, wherein the optimal bid is a bid that outbids a current winning bid and maximises the probability of winning in at least one auction, the optimal bid having a time of submission close to a deadline for the close of bidding.

According to third aspect of the invention there is provided a last minute electronic bidding system comprising: a user input interface for the inputting of user preferences; a monitoring means for monitoring auction data displayed by at least one electronic auction; a memory means for storing the auction data; a processor for processing the auction data; a bidding agent for evaluating and submitting an optimal bid to the or each electronic auction, a preference map accessible to the bidding agent and for storing the user preferences as determined by the bidding agent; a knowledge base accessible to the bidding agent and associated with the preference map and for storing the data mapped from the preference map; the bidding agent operating to process the data stored in the preference map and the knowledge base to evaluate the or each optimal bid to submit according to a predetermined bid model, wherein the optimal bid is a bid that outbids the current winning bid and maximises the probability of winning in at least one auction, the optimal bid having a time of submission close to a deadline for the close of bidding for the auction.

According to fourth aspect of the invention there is provided a method of bidding last minute using an electronic bidding agent comprising a user bidding model, the method comprising the steps of: storing user preferences input to the electronic bidding agent; monitoring at least one electronic auction; storing auction data retrieved from the or each electronic auction; evaluating an optimal bid from the user preferences and auction data using the user bidding model; and submitting the or each optimal bid to the or each auction, wherein the optimal bid is a bid that outbids a current winning bid and maximises the probability of winning in at least one auction.

According to fifth aspect of the invention there is provided a computer readable storage medium storing instructions that when executed by a computer, cause the computer to perform a method as described in the first and fourth aspects.

According to sixth aspect of the invention there is provided a messaging protocol for relaying communications between electronic bidding agents and electronic auctions using a method as described in the first and fourth aspects.

According to a seventh aspect of the invention there is provided a method of bidding in an auction by use of an electronic bidding agent, comprising: providing user preferences as an input to the electronic bidding agent; providing auction data as an input to the electronic bidding agent, the auction data including a time to completion of at least one auction; the electronic bidding agent determining a first likelihood that said at least one bid will be received before the completion of the auction and a second likelihood that any other bid will be received before the completion of the auction and submitting at least one bid in said at least one auction depending on said first and second likelihoods.

According to an eighth aspect of the invention there is provided data carrier storing code means defining an electronic bidding agent for use in an auction, the code means being adapted to program a processor to obtain user preferences from a user; obtain auction data relating to one or more auctions conducted over a distributed network, the auction data including a time to completion of at least one auction; determine a first likelihood that said at least one bid will be received before the completion of the auction and a second likelihood that any other bid will be received before the completion of the auction and to submit at least one bid in said at least one auction depending on said first and second likelihoods.

Other aspects and features of the present invention will become apparent to those ordinarily skilled in the art upon review of the following description of specific embodiments of the invention in conjunction with the accompanying figures.

Embodiments of the invention will now be described by way of example only, with reference to the drawings in which:

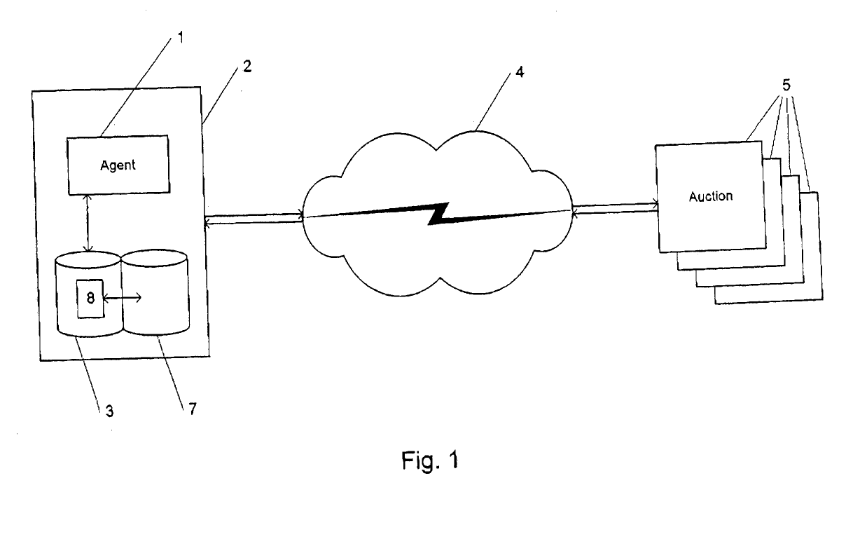

FIG. 1 is a schematic diagram of an embodiment according to the present invention;

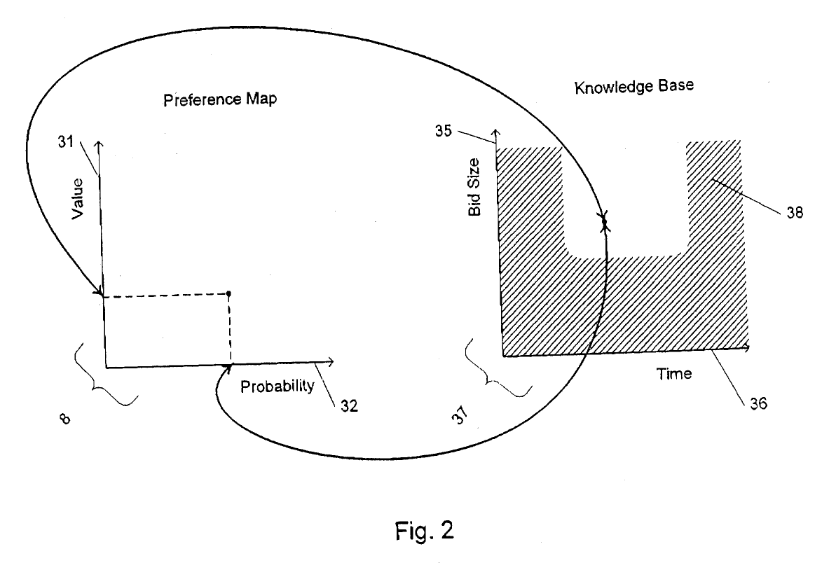

FIG. 2 is a schematic diagram of a preference map and knowledge base used with an embodiment in accordance with the present invention; and

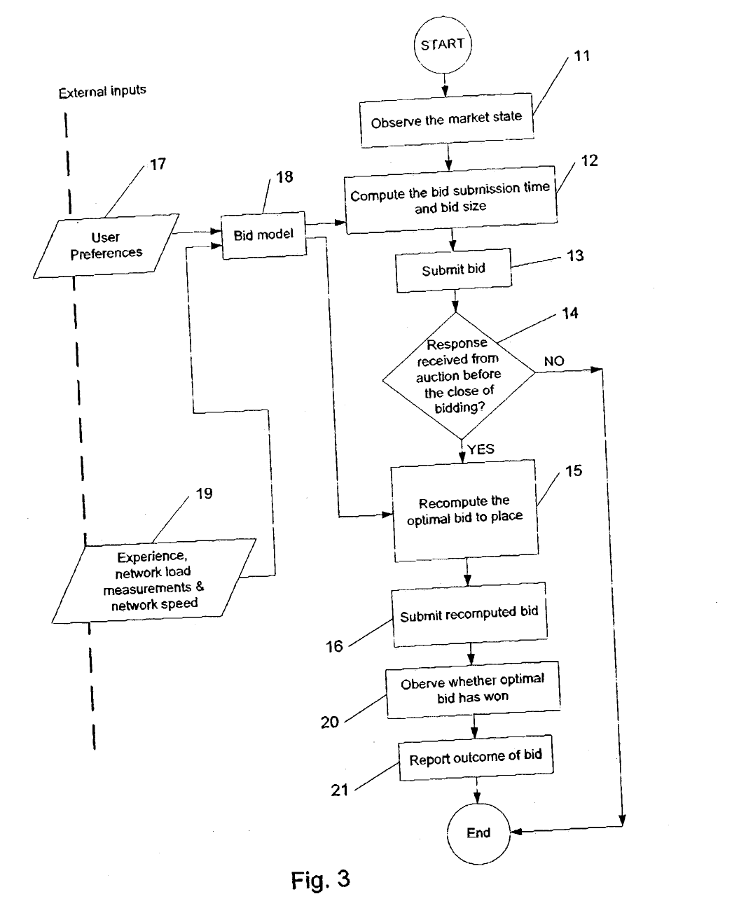

FIG. 3 is a block diagram of the steps taken by a bidding agent in submitting bids to an auction according to an embodiment of the present invention.

With reference to FIG. 1, a bidding agent 1 resides on a user's computer 2 and has access to the website of an electronic auction 5 through the Internet 4. The agent 1 is programmed with user preferences regarding risk and value. For example, does the user want to obtain the goods at a low price, or is it more important to the user to guarantee a purchase. In this context, the risk involved is that of losing a purchase against obtaining the goods at a low price. The agent 1 maintains a model 2 of the likelihood of a certain last minute bid succeeding and the value that such a last minute bid would give, were it successful, based on the bid's time of submission, price, size (number of goods) and the market 5 in which it is being bid. A user of such an agent 1 can then configure a utility function based on risk and value parameters, to constrain the set of last minute bids that the agent 1 should send.

The two factors on which the agent 1 bases (via the user's utility function) its choice of when and where to place a bid B, are the likelihood of the bid B arriving before the market 5 closes, and the likelihood that between the last observed bid and the close of the market 5 there is a bid or bids submitted by another agent or agents, which beat bid B. The agent 1 bases its estimates regarding these likelihoods on observations such as the likelihood that bid B arrives before market close, on observed instances where it submits a winning bid that is either accepted or rejected on the basis of arrival time (i.e. excluding those instances where B was out-bid), and on heuristics, which may be programmed into the agent 1 as necessary. These estimates are parametrized by whatever market factors may be appropriate—for example, current best bid at submission time, whereby a last minute increment of $1 may be consistently more likely to succeed in markets 5 with high current bids than in markets 5 with low current bids, or in markets 5 with fewer participants).

With reference to FIG. 3, when a market 5 enters the last-minute bid region (roughly speaking, the time period during which market participants are unlikely to hear about the agent's bid until the market is closed), the agent 1 observes 11 the market state, and computes 12 the bid submission time and value which optimize the user preferences 17 for profit and risk.

As the agent 1 is unlikely to hear back from the auction 5 before the market doses, the employment of such a strategy provides the agent 1 with only one opportunity of bidding, and there are no further opportunities to do anything else. However, it is possible that if the timing of the bid is just right, the user may hear back 14 from the market 5. In this case the agent 1 recomputes 15 the optimal bid to place, given the user preferences 17 and conditioned on the likelihood of its standing bids succeeding.

The likelihood of the agent 1 receiving further information from the market 5 once it has submitted its bid, depends on the network speed and load at the time of submitting the bid which are variable factors. Hence it is difficult to predict whether a bid sent, for example a second before the close, reaches the market in time, as it may take the bid two seconds or even half a second to reach the market depending on the volume of network traffic around at the time of making the bid. If at some later time the agent 1 receives 14 further information from the market, it recomputes 15 the optimal bid to place, given the user preferences 17, conditioned on the likelihood of its standing bid succeeding.

To compensate for this eventuality, the agent 1 will have within it a model 18 of how likely it is for a given bid to arrive at a given market 5. The model 18 is built up both by experience 19 and by programming in how long it would take for the bid to arrive based on measurements 19 of the network load at the time immediately preceding making the bid. Based on the model 18, the agent 1 will have an idea of how likely it is for the user's bid to arrive before the close of bidding for a specified time of sending the bid before the deadline.

The amount the agent 1 should bid depends on two parameters, the time at which the agent sends the bid to the market, and the value of the bid to the user. If the agent 1 makes a minimal bid over the current auction price, then that is the best price the user can hope to bid at. But another user may be employing last minute bidding tactics as well, in which case the original user is unlikely to win the auction. Therefore, the higher the user's bid, the more likely the user is to get the goods, but the lower the bid's value becomes to the user.

Before the agent 1 can be used, it needs to be programmed with or have access to a model 18 of how likely it is to succeed at auction with a bid B given any point within a two dimensional bid space based on the two variables of risk and value. In addition, the agent 1 also needs to know the user preferences 17 in order to use a method of optimisation to choose the best option, i.e. that bid which is most likely to succeed with the highest value option given the preferences of the user.

Nevertheless, depending on the amount of information that is available for the auction 5, the agent 1 may be programmed with a model 18 relying on a number of other variables, such as the number of participants to the auction. Thus the more information there is known about a particular auction, the greater the initial accuracy of the agent 1 in placing the bids in accordance with the user preferences.

As shown in FIG. 1, the agent 1 may typically reside locally on the user's computer 2, and has access to a database 3 holding the user preferences which may be in the form of a preference map 8. Optimisation of the preferences is conducted with respect to the model of how likely the agent 1 is to win a particular auction. The knowledge on which the agent 1 makes its decisions, i.e. heuristics and/or the data points making up the model, are stored in a knowledge base 7. The agent 1 thus mediates between the knowledge base 7 and the preference map 8 by optimising the preferences over the knowledge it has With the user's computer connected to the Internet, the agent 1 may submit a bid by posting a message to the website of the auction 5.

The mode of operation is as follows. The user provides the agent 1 with information of what the user would like to buy together with the user's risk preferences. The agent 1 is then able to perform all the necessary calculations to formulate a model 18. At this point in time the agent 1 will not be interacting with any markets. When a user sees that there are auctions 5 taking place, the user activates the agent 1 supplying it with information related to the auctions 5, for example, the identity of the auction 5, the bidding deadline, what the user wants to purchase, and risk and value preferences. The agent 1 uses this information to calculate a bid 6, and then waits until the perfect moment which it has calculated, for submitting the bid 6. When this time arrives the agent 1 submits its bid 6 by posting a message to the website of the auction 5. After submitting the bid 6, the agent then reports 21 the outcome of the bid 6 to the user.

The agent 1 may be trained to improve its accuracy by observing 20 whether previously submitted last minute bids were successful. In addition, heuristics may be used to program the agent 1, and can be built up from a theory or model formulated from experience in, for example, network traffic. Even without taking part in an auction 5, it is possible for an observer to observe the bid history, so the observer may know what the winning bid was and use such observations to train the agent 1. Here the agent 1 does not bid in the auction 5, but at the moment the agent 1 would have bid, the observer notes what the current bid is and waits until the auction 5 is over to see what the winning bid was. This technique allows the agent 1 to observe what bid it would have needed to submit in order to win the auction 5. Such a method allows the user to train the agent 1 without the expenditure involved in participating in auctions 5.

In the case of the agent 1 operating in a single auction 5, each bid gives rise to a potential value and a potential likelihood (probability) of succeeding. FIG. 2 shows an example of a preference map 8 that may be used to store the user's preferences. The preference map 8 measures Value 31 on one axis and Probability 32 on the other axis. Associated with each potential point on the map that represents the gamble, is a number which represents how acceptable the gamble is. This number will be higher for 9 higher probability of succeeding, and high probability of succeeding high value is preferred to low value low probability of succeeding. However, what typically occurs is that if the user wants a high value then the user will usually have to settle for a low probability of succeeding i.e. winning the auction, in particular by bidding very late in the auction 5. At the other end of the scale, if the user wants to go for a high probability of winning the auction 5, the user will normally have to settle for a low value, which means bidding a very high amount and not getting much in return. These are the parameters that the user expresses preference over.

The agent 1, on the other hand, has a two dimensional chart 37 which plots the size of bid 35 (Bid Size) against time remaining until the end of the auction 36 (Time). For each point on the chart the agent 1 will associate a likelihood of winning the auction 5. The maximum value of Time 36 is the longest period of time the agent 1 can refrain from bidding before having to bid in order to submit the bid before the end of the auction 5.

The knowledge base 7 contains a function for determining the likelihood of winning the auction. The function varies with the Time 36 and the Bid Size 35. For each potential bid in time, the Bid Size 35 is mapped directly onto the Value 31 in the preference map, and the likelihood of winning is mapped onto the Probability 32 in the preference map. Then the user preference may simply be read off from the preference map. Therefore, for each point in the knowledge base 7 a preference can be derived according to the user.

As the Bid Size 35 increases, the Value 31 decreases and usually the user preference decreases. As the Bid Size 35 goes to zero, the Probability 32 goes towards zero, e.g. if a very small bid is submitted it is unlikely to be successful. If a bid is submitted towards the end of the time for bidding, it is more unlikely to arrive at the auction before the close of bidding, and if the bid is submitted too early it is unlikely to succeed, as it is likely to be out bid. All the edges of the region 38 marked with hashes indicate where the user preference would be near zero, however, somewhere in the middle of the map there is maximum for the function, according to the mathematics employed. Therefore, the function is bounded by an area in two-dimensional space and the model for the agent 1 seeks to optimise the function, i.e. the preference. There are many known mathematical ways of doing this any one of which may be used. This is because the user preferences are expressed in a market independent way.

Typically, user preferences may vary market to market, but if there are some things that the user will always specify, for example that the user is very conservative with respect to risk, then these preferences could be applied to any market. It is then possible to have an agent 1 that can be left alone to keep bidding in different auctions 5 until it buys an item or meets a criteria, such as buy as many items of the product as specified. In stand-alone mode the agent 1 will repeatedly wait for the right moment and then send out a last minute bid.

If the user, and therefore the agent 1, knows how many auctions 5 there are then this information may affect the risk parameter used by the agent 1 for formulating the bid and when to submit the bid. For example, if the agent 1 knows there is a high number of auctions 5 available for essentially the same goods, then the agent 1 may employ more bids having a high risk factor. This type of modified behaviour may be programmed or built into the agent's model. The user inputs data in to the agent 1 regarding what goods are required along with its preferences, via the computer 2; the agent 1 then deduces from those preferences and from the options available, a meta-preference map. More generally, the agent 1 looks at the collection of auctions 5 available and then calculates, given what the user wants, a structure for the complete collection of bids to maximise the user's chances of obtaining the goods. Some auctions may, for example, have a faster and more reliable connection to the user, so that it is possible to bid much closer to the deadline. Therefore, as well as optimising for each auction 5, the agent 1 may optimise over a whole collection of auctions 5 and choose the best set of last minute bids to make. To implement this technique the software will be similar to that for a simple auction except it will now be over a multi-dimensional bid-space with respect to a preference map. As before, the preference map will be deduced from the user's root preference map and from knowledge about the auctions 5 that happen to be open at that time. Consider the following example. A user is willing to submit a bid at a price X if there is a greater than 80% probability that the user will get the goods. If there were a hundred auctions, then the agent may choose to wait until much later to submit a bid when there may be a lower than 80% probability of winning the auction, for instance at a time where there is only a 2% probability. As the agent 1 will be bidding in 100 auctions the agent 1 takes the root piece of information about what the user wants and extrapolates the best course of action to take to fulfil the user's expressed requirements.

The agent 1 described above could be implemented with basic agent software to send bids to on-line auction/exchange sites, and a logical core, programmed in virtually any language.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form or in any other form suitable for use in the implementation of the processes according to the invention. The carrier be any entity or device capable of carrying the program.

For example, the carrier may comprise a storage medium, such as ROM, or example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

The agent described above would act simultaneously in any number of markets, because although the calculus is market specific, it may be adapted and applied to any and all markets simultaneously.

Although the invention has been shown and described with respect to a best mode embodiment thereof, it should be understood by those skilled in the art that the foregoing and various other changes, omissions and additions in the form and detail thereof may be made therein without departing from the scope of the invention as claimed.

1. A method of operating an electronic bidding agent for bidding in an electronic auction, the method comprising the steps of:
inputting user preferences;
constructing a preference map from the user preferences;
monitoring at least one electronic auction;
retrieving auction data from the or each auction;
processing the auction data;
mapping the data from the preference map using the processed auction data to generate a knowledge base for the or each auction;
evaluating using the knowledge base an optimal bid or bids to submit to the auction or auctions to outbid the current bid or bids and to maximise the probability of winning at least one auction; and
submitting the optimal bid or bids to the auction or auctions, wherein the optimal bid has a value and a time of submission close to a deadline for the close of bidding.

2. A method according to claim 1, wherein said method is conducted in real time.

3. A method as claimed in claim 1 or 2, wherein the step of processing the auction data comprises:
storing auction data displayed by the auction or auctions in memory; and
determining a number of active bids of the electronic bidding agent already sent to the auction or auctions, if any.

4. A method as claimed in any one of claims 1 to 3, wherein the steps of:
mapping the data from the preference map using the processed auction data to generate a knowledge base for the or each auction; and
evaluating using the knowledge base an optimal bid or bids to submit to the auction or auctions to outbid the current winning bid or bids and to maximise the probability of winning at least one auction,
are carried out according to a pre-determined user bidding model.

5. A method as claimed in claim 4 wherein the user bidding model is constructed by pre-storing prior observed bid histories and network load statistics.

6. A method as claimed in claim 4, wherein the user bidding model is constructed on the basis of heuristics.

7. An electronic bidding agent employing last minute behaviours comprising:
an user interface for enabling user preferences to be input and for communicating with the user;
monitoring means for monitoring auction data received from at least one electronic auction; and
a bid model for processing the auction data and the user preferences to evaluate an optimal bid for the or each electronic auction,
the optimal bid being a bid that outbids a current winning bid and maximises the probability of winning in at least one auction, the optimal bid having a time of submission close to a deadline for the close of bidding.

8. An electronic bidding agent according to claim 7, further comprising:
a preference map for storing the user preferences and accessible by the user bidding model;
a data mapper for mapping the data in the preference map according to the bid model and by using the processed auction data; and
a knowledge base accessible by the bid model and associated with the preference map, for storing the data mapped from the preference map,
the value and time of submission for the or each optimal bid being determined from the mapped data stored in the knowledge base.

9. An electronic bidding agent according to claim 7 or 8 wherein the agent is operable in real time.

10. A last minute electronic bidding system comprising:
a user input interface for the inputting of user preferences;
a monitoring means for monitoring auction data displayed by at least one electronic auction;
a memory means for storing the auction data;
a processor for processing the auction data;
a bidding agent for evaluating and submitting an optimal bid to the or each electronic auction;
a preference map accessible to the bidding agent and for storing the user preferences as determined by the bidding agent;
a knowledge base accessible to the bidding agent and associated with the preference map and for storing the data mapped from the preference map; and
the bidding agent being operable to process the data stored in the preference map and the knowledge base so as to evaluate the or each optimal bid to submit according to a pre-determined bid model,
the optimal bid being a bid that outbids the current winning bid and maximises the probability of winning in at least one auction, the optimal bid having a time of submission close to a deadline for the close of bidding for the auction.

11. A computer readable storage medium storing instructions that, when executed by a computer, cause the computer to perform a method of operating an electronic bidding agent for bidding in an electronic auction according to any one of claims 1 to 6.

12. A method of bidding last minute using an electronic bidding agent comprising a user bidding model, the method comprising the steps of:
storing user preferences input to the electronic bidding agent;
monitoring at least one electronic auction;
storing auction data retrieved from the or each electronic auction;
evaluating an optimal bid from the user preferences and auction data using the user bidding model; and
submitting the or each optimal bid to the or each auction,
the optimal bid being a bid that outbids a current winning bid and maximises the probability of winning in at least one auction.

13. A computer readable storage medium storing instructions that, when executed by a computer, cause the computer to perform a method of bidding last minute using an electronic bidding agent according to claim 12.

14. A messaging protocol for relaying communications between electronic bidding agents and electronic auctions using the method according to any one of claims 1 to 6 or 13.

15. A method of bidding in an auction by use of an electronic bidding agent, comprising:
providing user preferences as an input to the electronic bidding agent;
providing auction data as an input to the electronic bidding agent, the auction data including a time to completion of at least one auction;
the electronic bidding agent determining a first likelihood that said at least one bid will be received before the completion of the auction and a second likelihood that any other bid will be received before the completion of the auction and submitting at least one bid in said at least one auction depending on said first and second likelihoods.

16. A method as claimed in claim 15, wherein said auction data includes network performance data relevant to the network connection between the electronic bidding agent and an auction server.

17. A method as claimed in claim 15 or claim 16, wherein said auction data includes bid histories in said at least one auction or in auctions comparable to said at least one auction.

18. A method as claimed in any of claims 15 to 17, wherein said at least one bid has a value dependent on the value of the bid to the user and the time relative to the completion of the auction at which the bid is sent by the electronic bidding agent.

19. A data carrier storing code means defining an electronic bidding agent for use in an auction, the code means being adapted to program a processor to obtain user preferences from a user;
obtain auction data relating to one or more auctions conducted over a distributed network, the auction data including a time to completion of at least one auction;
determine a first likelihood that said at least one bid will be received before the completion of the auction and a second likelihood that any other bid will be received before the completion of the auction and to submit at least one bid in said at least one auction depending on said first and second likelihoods.
